(19) United States
(12) Patent Application Publication
(10) Pub. No.: US 2011/0232087 A1
(43) Pub. Date: Sep. 29, 2011

(54) METHOD FOR MANUFACTURING LED LIGHT STRINGS

(76) Inventor: Cheng-Chung Chiu, Xinzuang City (TW)

(21) Appl. No.: 12/748,904

(22) Filed: Mar. 29, 2010

(51) Int. Cl. H01B 19/00

(52) U.S. Cl. 29/887

(57) ABSTRACT

A method for manufacturing light emitting diode light strings is provided. A plurality of bare electric wires is rolled by rollers to have a flat top surface. Then the rolled bare electric wires are pasted on an insulating film. The LEDs are soldered on each pair of bare electric wires, which includes two adjacent bare electric wires. Each pair of bare electric wires together with the LEDs soldered thereon is separated by dividing the insulating film. The LEDs and the bare electric wires are packaged to protect the connection thereof.

### BACKGROUND OF THE INVENTION

1. Field of Invention

The present invention relates to method for manufacturing light strings, and more particularly, to a method for manufacturing LED light strings for mass production.

2. Related Art

In the past, Christmas tree lights have been made using for the most part either incandescent bulbs or neon lamps. These lights usually come in strings of 25, 50 or 100 bulbs or lamps attached together in a series arrangement. The strings can be plugged into one another up to an allowable power amount. Light strings of incandescent bulbs tend to burn out rapidly, use a great amount of energy at 115 VAC (volts alternating current), and run excessively hot, thus having very unsafe features. A string of neon lamps also runs hot to obtain a good brightness level, uses a good amount of energy at 115 VAC, needs a high value resistor in series to limit the current, and because of its small diameter wiring and its general overall appearance many users get electrical shocks trying to change lamps with the power on.

Incandescent lamps consist of a resistive tungsten filament suspended by support wires with a vacuum inside a glass envelope. They are very susceptible to damage from mechanical shock or vibration and voltage spikes or transients.

LED lights have garnered a lot of attention over the past couple of years. With their distinct look and energy-costs reduction, they have become a fast favorite for Christmas decorators. LED lights are also safer than traditional Christmas bulbs. They emit less heat so they pose less of a fire risk when put on trees or combined with other decorations. All lights create fire hazards when they are lit near flammable materials or left on for too long but you can reduce the danger by changing the type of bulb you use. The lights also reduce the risk of burns for children and pets.

However, the LED light strings are difficult to produce. The LED light strings were made by hand and relied on the individual worker's skills. Therefore, the quantity of production is limited and the costs are high.

### SUMMARY OF THE INVENTION

The invention provides a method for manufacturing LED light strings that permit efficient mass production of LED light strings in a simple way.

To address or solve the above problem, the exemplary embodiments provide a method for manufacturing LED light strings. The method includes: rolling a plurality of bare electric wires; pasting the rolled bare electric wires on an insulating film; soldering a plurality of LEDs on each pair of bare electric wires, which includes two adjacent bare electric wires; dividing the insulating film to separate each pair of bare electric wires together with the LEDs soldered thereon; and packaging the LEDs and the bare electric wires.

According to this method, the bare electric wires are rolled to have a flat top surface respectively, which is wide enough for the LEDs to paste. By rolling the bare electric wires, the LEDs can be pasted thereon by mechanically processing. Since the LEDs are pasted by mechanically processing instead of by hand, large amounts of the LED light strings can be formed at one time by simple processes, enabling the improvement of production efficiency.

Preferably the packaging step further has: placing each pair of bare electric wires into a heat shrinkable tube; and wrapping tightly the pair of bare electric wires, the LEDs and the divided insulating film by heating the heat shrinkable tube. Thus, a plurality of LEDs can be packaged at one time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIGS. 1A, 1B, 1C, 1D, and 1E are schematics illustrating a method for manufacturing LED light strings in an exemplary embodiment;

FIGS. 2A and 2B are schematics illustrating an example of bare electric wires after being rolled in an exemplary embodiment;

FIG. 3 is a schematic illustrating an example of the LED light string when packaging in an exemplary embodiment; and

FIGS. 4A and 4B are schematics illustrating another example of the LED light string when packaging in an exemplary embodiment.

### DETAILED DESCRIPTION OF THE INVENTION

A method for manufacturing LED (light emitting diode) light strings according to the exemplary embodiments will be described below with reference to the drawings.

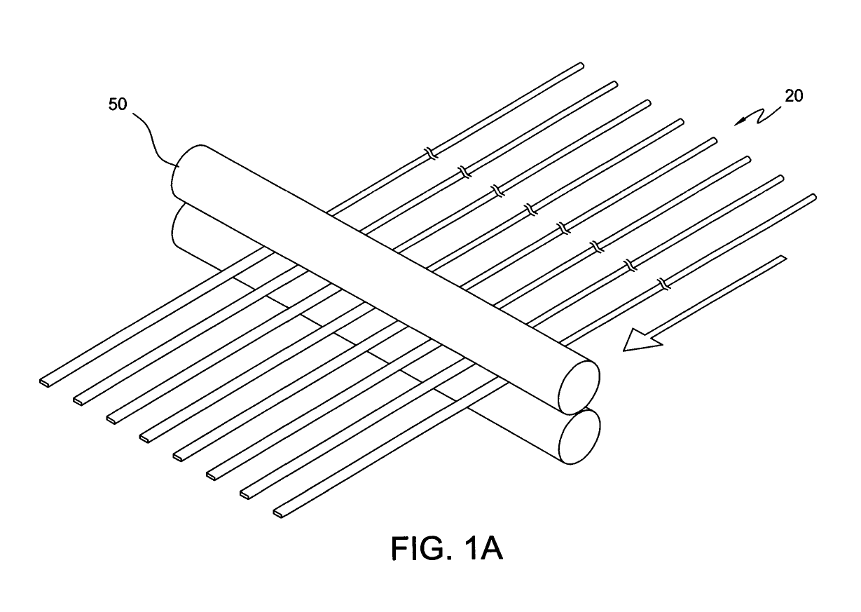

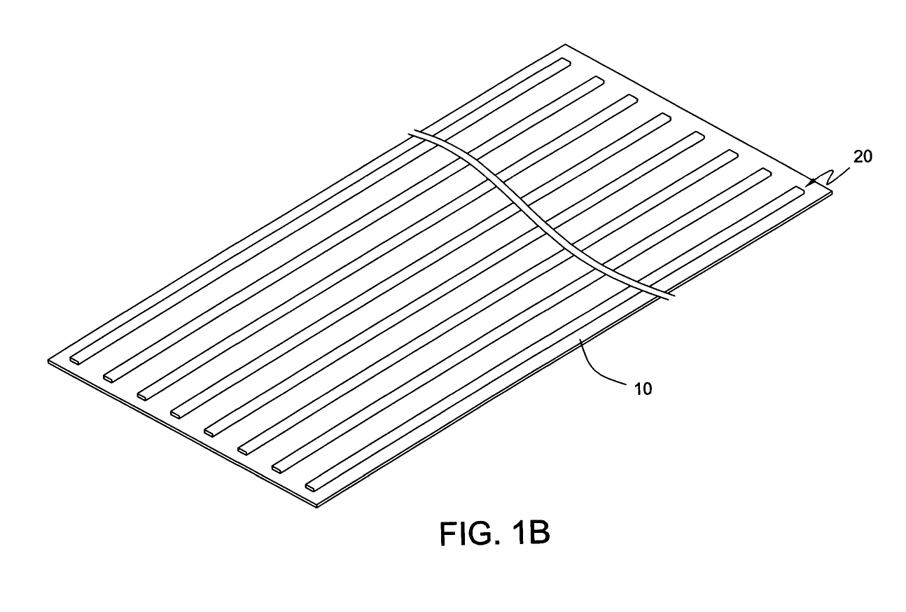

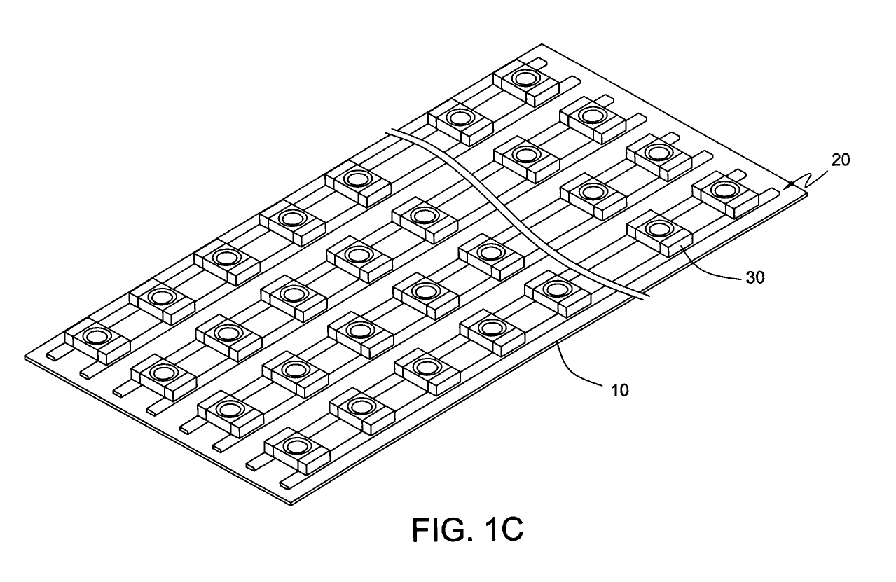

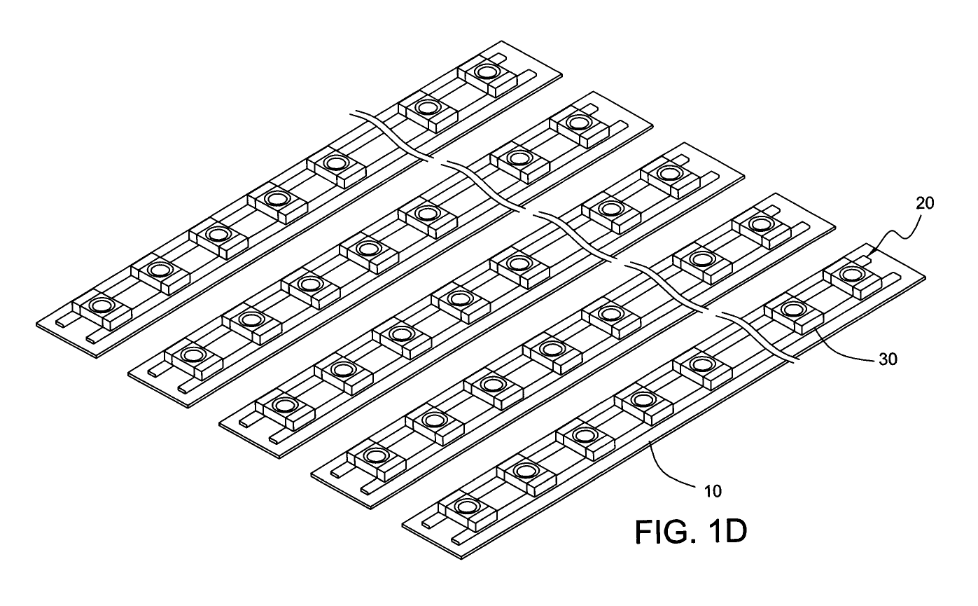

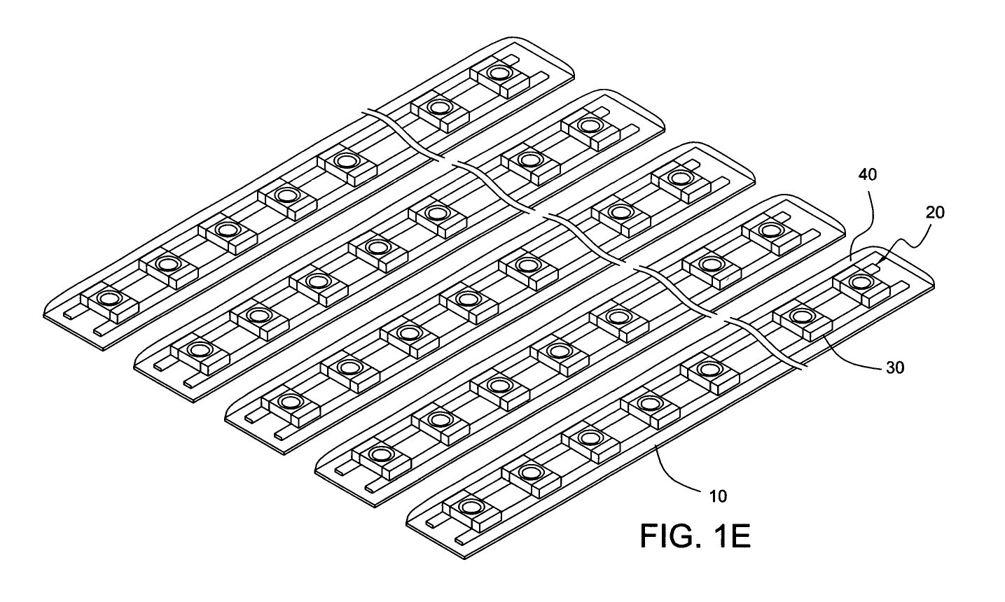

FIGS. 1A to 1E are views for illustrating the method for manufacturing LED light strings of the present exemplary embodiment.

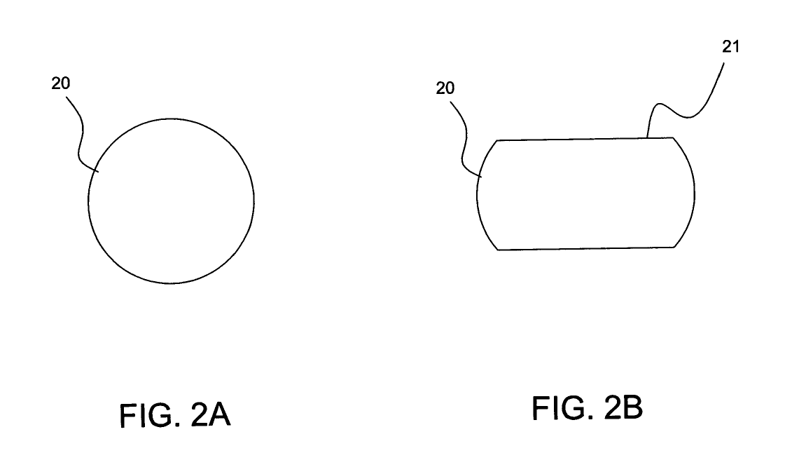

The bare electric wires 20 are metal conductive wires without insulation covers, such as PVC (Polyvinylchloride) or XLPE (Cross Linked Polyethylene). Usually, the bare electric wires 20 are made of copper. AS shown in FIG. 1A, the bare electric wires 20 are rolled by the rollers 50. In general, the bare electric wire 20 has a substantially round cross-section, please refer to FIG. 2A. After being rolled, the bare electric wire 20 will be deformed to have a flat top surface 21 in cross-section, as shown in FIG. 2B.

The rollers 50 are also called the rolling machine, or industrial rollers. The rollers 50 are usually paired. Therefore, the bare electric wire 20 is deformed on opposite sides, top and bottom sides as shown in FIG. 2B. Also, the bare electric wire 20 will be deformed symmetrical on opposite sides. The deformation of the bare electric wire 20 is depended on the gap between the paired rollers 50. The control of the rollers 50 is well-known by the person skilled in this art.

Then, the rolled bare electric wires 20 are pasted on a insulating film 10, as shown in FIG. 1B. Preferably, the insulating film 10 is made of insulating, waterproof material, for example, PVC. The insulating film 10 would apply a thin glue layer before pasting for easily to paste.

Please refer to FIG. 1C, a plurality of LEDs 30 are soldered on the bare electric wires 20. The LEDs 30 are, for example, Surface-mount device-type LEDs (SMD-type LED), DIP-type LEDs, LED LAMP, T1, T13/4, T5, axial-leaded “polyleds”, and high power packages such as the SuperNova, Pirahna, or Brewster lamps, all of which are available with a variety of options known to those skilled in the art such as color, size, beam width, etc. The flat top surface 21 of the bare electric wires 20 have to be wide enough for the LEDs 30 to paste, as shown in FIG. 2B. Thus, the deforming requirement of the bare electric wires 20 is depended on the LEDs 30 to be pasted.

Due to the LEDs 30 have two poles, the positive pole and the negative pole, the LEDs 30 should be soldered on two individual are electric wires 20. Therefore, we can define two adjacent bare electric wires 20 as a pair of bare electric wires 20. On the other hand, each LED 30 is soldered on a pair of bare electric wires 20.

Accordingly, the rolled bare electric wires 20 have to be pasted on the insulating film 10 with proper intervals between each others for the LEDs 30, as shown in FIGS. 1B and 1C. Preferably, the rolled bare electric wires 20 are be pasted on the insulating film 10 with aligned arrangement to prevent short and to be convenient for soldering the LEDs 30. On each pair of bare electric wires 20, the LEDs 30 are also soldered with proper intervals.

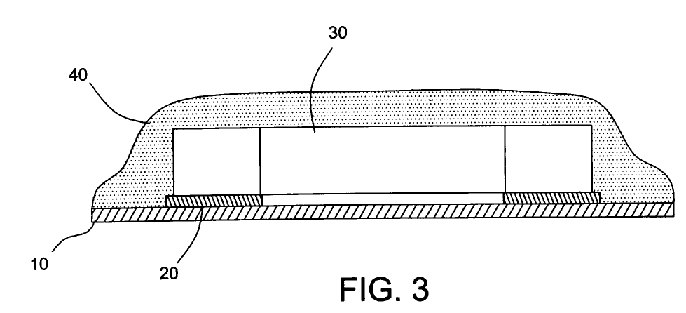

When soldering is finished, the LEDs 30 are tested to ensure each LED 30 works. Then, each pair of bare electric wires 20 together with the LEDs 30 soldered thereon are separated by dividing the insulating film 10, as shown in FIG. 1D. A transparent material, such as packaging adhesive, or silicone, is used to packaged the LEDs 30, as shown in FIG. 1E. After packaging, the LEDs 30 and the connection between the LEDs 30 and the bare electric wires 20 are protected and waterproof. Please refer to FIG. 3, only the LEDs 30 are packaged. However, in this embodiment, the LEDs 30 and the whole bare electric wires 20 are packaged to provide more protective, as shown in FIG. 2E.

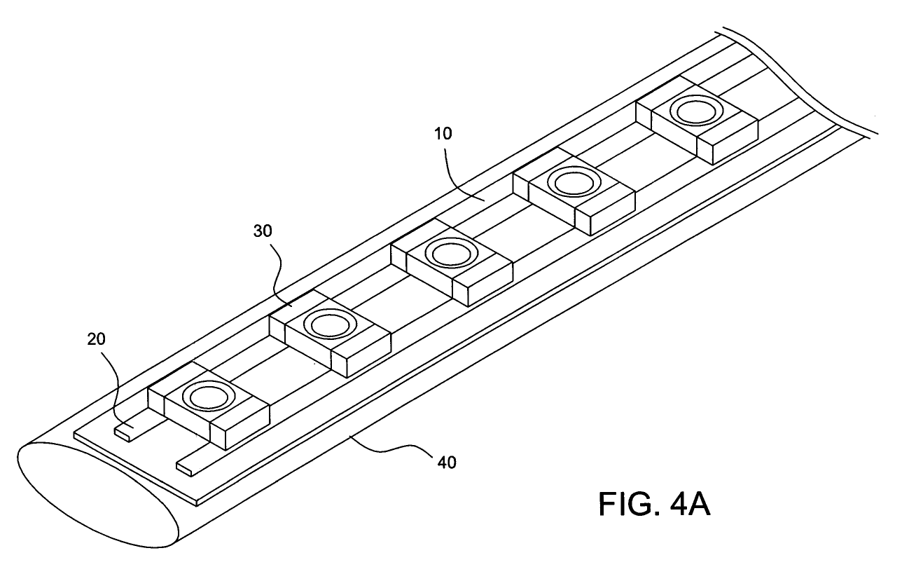

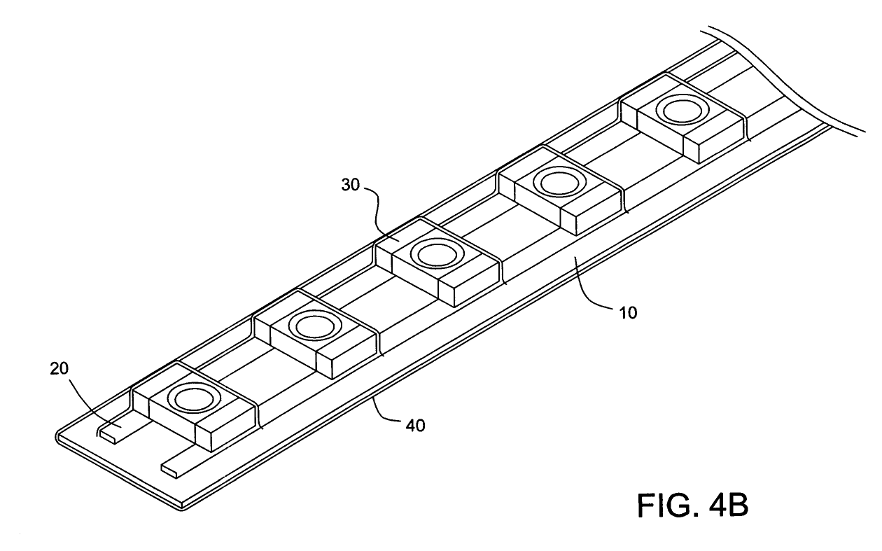

FIGS. 4A and 4B are views for illustrating another embodiment of the method for packaging.

Each pair of bare electric wires 20 are placed into a heat shrinkable tube 40. The heat shrinkable tube 40 is made of heat shrinkable and transparent material. After heating the heat shrinkable tube 40, the heat shrinkable tube 40 is wrapped tightly the pair of bare electric wires 20, the LEDs 30 and the divided insulating film 10. Such packaging method is more helpful for mass production.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for manufacturing LED (light emitting diode) light strings, comprising the steps of:
rolling a plurality of bare electric wires;
pasting the rolled bare electric wires on an insulating film;
soldering a plurality of LEDs on each pair of bare electric wires, which includes two adjacent bare electric wires;
dividing the insulating film to separate each pair of bare electric wires together with the LEDs soldered thereon; and
packaging the LEDs.

2. The method of claim 1, wherein the bare electric wires are rolled by rollers.

3. The method of claim 1, wherein the bare electric wires have a substantially round cross-section.

4. The method of claim 3, wherein the bare electric wires are deformed by rolling to have a flat top surface respectively.

5. The method of claim 4, wherein the flat top surface of the bare electric wires is wide enough for the LEDs to paste.

6. The method of claim 1, wherein the LEDs are packaged by a transparent material.

7. The method of claim 1, wherein the step of packaging the LEDs further comprising:
placing each pair of bare electric wires into a heat shrinkable tube; and
wrapping tightly the pair of bare electric wires, the LEDs and the divided insulating film by heating the heat shrinkable tube.

8. The method of claim 1, wherein the package is waterproof.

9. The method of claim 1, wherein the step of packaging the LEDs further packaging the bare electric wires.
